(19) United States
(12) Patent Application Publication
(10) Pub. No.: US 2006/0173798 A1
(43) Pub. Date: Aug. 3, 2006

(54) Method of providing tracking numbers for a mail piece

(76) Inventor: Pascal Charroppin, Trumbull, CT (US)

Correspondence Address: PERMAN & GREEN, 425 POST ROAD, FAIRFIELD, CT, 06824, US

(21) Appl. No.: 11/047,290

(22) Filed: Jan. 31, 2005

(51) Int. Cl. G06F 17/00

(52) U.S. Cl. 705/404

(57) ABSTRACT

A method of providing mail piece labeling and tracking includes allocating at least one tracking number a postal service provider customer, associating the at least one tracking number with information about a mail piece, applying the at least one tracking number to the mail piece, and using the at least one tracking number to track the delivery progress of the mail piece.

### BACKGROUND

The presently disclosed embodiments relate to processing mail pieces and, more particularly, to a system for labeling and providing tracking services for mail pieces.

### BRIEF DESCRIPTION OF RELATED DEVELOPMENTS

Timely delivery of certain mail pieces may be important. There may also be a need to monitor or track the progress of a mail piece to identify its location, to predict its delivery date, and to verify its actual delivery.

One known method of determining the delivery status a mail piece is used by the US postal service to determine at which post office the mail piece is presently located.

Another known method includes providing a postcard or other return mail piece with the original piece of mail. Upon delivery, the return mail piece is filled out and mailed back to the originator.

It would be advantageous for a service provider to provide a customer with tracking numbers for mail pieces, and the ability to associate the tracking number with information about the mail piece, and to provide tracking services for the mail piece.

### SUMMARY OF THE EXEMPLARY EMBODIMENTS

The exemplary embodiments described herein are generally directed to providing tracking numbers to a service provider customer, providing the customer with the ability to associate each tracking number with information about its associated mail piece, and providing tracking services to the customer.

The disclosed embodiments include providing bulk labels with pre-printed tracking numbers to a service provider customer. The customer is provided with the ability to associate each tracking number with information about its associated mail piece by entering that information, for example, into a book from which the labels are supplied, or a data base. The label is applied to the associated mail piece. Tracking services are provided by entering the tracking number into a system that provides delivery verification, for example, a franking machine connected to a postal service infrastructure.

The disclosed embodiments also include providing blank labels to a service provider customer. The customer is provided with a block of tracking numbers and the ability to associate each tracking number with information about its associated mail piece by entering that information, for example, into a book or data base. The label is printed with its individual tracking number assigned from the block of tracking numbers and affixed to the mail piece. Tracking services are provided by entering the tracking number into a system that provides delivery verification, for example, a franking machine connected to a postal service infrastructure.

The disclosed embodiments further include allocating tracking numbers to a customer, associating a tracking number mail piece information related to a particular mail piece and entering the tracking number into the franking machine. The tracking number and indicia may then be directly printed onto the mail piece. In this way, the mail piece is labeled directly, without the need for a separate label. The associated tracking number and mail piece information, along with any other information, may be uploaded to the postal services infrastructure for tracking purposes.

### BRIEF DESCRIPTION OF THE DRAWINGS

The foregoing aspects and other features of the present invention are explained in the following description, taken in connection with the accompanying drawings, wherein:

FIG. 1 shows a system 100 utilized for practicing the disclosed embodiments;

FIG. 2 shows a block diagram of a postage meter 115;

FIG. 3 depicts a block diagram of a postal infrastructure data center;

FIG. 4 shows a flow diagram of an exemplary process providing tracking numbers and services;

FIG. 5 shows one form of supplying numbered labels to a customer;

FIG. 6 shows an embodiment for associating a tracking number and mail piece information by entering them into a local database;

FIG. 7 shows another exemplary process for providing tracking numbers and services;

FIG. 8 shows yet another exemplary process for providing tracking numbers and services; and

FIG. 9 shows an exemplary mail piece bearing a tracking number according to the disclosed embodiments.

### DETAILED DESCRIPTION OF THE PREFERRED EMBODIMENTS

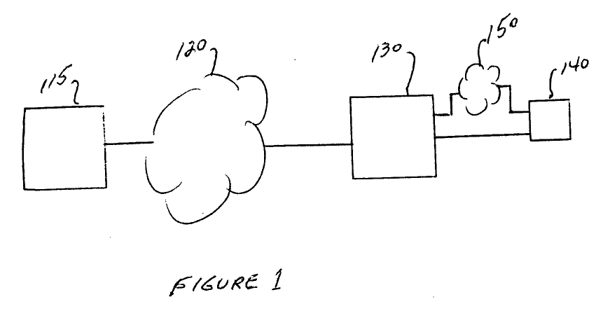

FIG. 1 illustrates a system 100 in which the presently disclosed embodiments may be practiced. Although the present invention will be described with reference to the embodiments shown in the drawings, it should be understood that the present invention can be embodied in many alternate forms of embodiments. In addition, any suitable size, shape or type of elements or materials could be used.

System 100 includes at least one franking device, shown in FIG. 1 as a meter 115, generally located at a customer site and operated by a customer, connected through a first network 120 to a postal infrastructure data center 130, typically operated by a postal service provider. The postal infrastructure 130 may be connected to a carrier, for example a postal authority 140, either directly or through a second network 150.

The carrier 140 may generally provide tracking numbers to the postal service provider through data center 130. The carrier 140 may also provide status and delivery information about a mail piece upon an inquiry by the data center 130. For example, after a tracking number has been allocated to the postal service provider, the carrier may collect information about the location of a mail piece having the tracking number within the carriers mail stream. The carrier may collect information regarding through which carrier installation the mail piece may have traveled, a predicted and actual delivery time and location. For example, once the mail piece is introduced into the mail stream, the data center 130 may poll the carrier 140 a number of times per day to ascertain the location of the mail piece as designated by the tracking number. Carrier 140 may provide status information which may include a list of facilities and the respective entry and exit times of the mail piece. The data center 130 may in turn provide this information to the customer. In one exemplary aspect of the tracking services, if the data center 130 fails to receive status information after a period of time, a notification may be sent to the customer.

The present invention is particularly suitable in an environment where the postal service provider is authorized to generate or otherwise provide tracking numbers, which for the purposes of the invention includes planet codes. The service provider generally has access to status information for the subject mail pieces, either from within its own infrastructure or from an external source, for example, a database of the postal authority 140. The service provider may be authorized by the postal authority to provide tracking numbers and to obtain status information, if such authorization is required.

It is a feature of the disclosed embodiments for the postal service provider to provide tracking numbers to a service provider customer, provide the customer with the ability to associate each tracking number with information about a related or associated mail piece, and to provide tracking services to the customer.

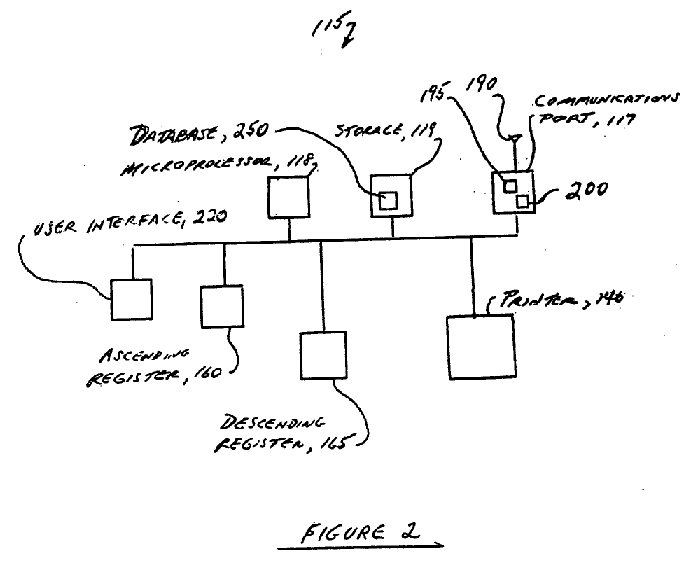

FIG. 2 shows a general block diagram of meter 115. Meter 115 may include a communications port 117 and a microprocessor 118 for performing electronic accounting functions, control functions, and franking functions according to programs stored in a storage device 119. Some of these functions or subsets of these functions may be grouped within a secure perimeter as what is commonly referred to as a Postal Security Device (PSD).

Storage device 119 generally stores machine readable program code which is adapted to cause microprocessor 118 to perform the functions of the disclosed embodiments. Storage device 119 may utilize optical, magnetic, semiconductor, electronic, or other types of suitable devices to store the program code. Storage device 119 may also include a database 250 which may be used to organize data.

Microprocessor 118 typically performs the electronic accounting functions in relation to franking items. Data associated with the accounting functions may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 160, the accumulated total value of postage charges dispensed may be stored in a descending register 165, and the count of items may be stored in an items count register 170. The various registers may be located in storage device 119.

The franking functions performed by microprocessor 118 typically include marking items with an indication of funds, or other marks that represent value, including for example, providing postage, tickets, or authorization to use services. The franking functions also include reporting the number of items, value marked and other parameters to the accounting functions. The provision of such markings are referred to herein as indicia services.

The meter 115 may generally provide indicia services utilizing a user interface 220 and a printer 140. The meter may be capable of receiving user commands including franking instructions from the user interface 220 and may be capable of franking a label, directly franking a mail piece, or franking any other suitable substrate using printer 140. The provision of indicia services is performed by microprocessor 118 under the control of programs located in storage device 119. The user interface may also be used to allow a user to communicate wit the data center 130. For example, the data center may notify a customer of non-delivery of a mail piece or of the status of a mail piece, as described herein, utilizing the user interface 220.

Meter 115 is advantageous in that it may be portable thus allowing a user to place meter 115 in a specific location on or over a substrate and frank or print an object. Meter 115 may be capable of printing stamps, barcodes, addresses, planet codes, images, text, indicia, logos, graphics, or any other printable item in any desired order. For example, the user may be able to position meter 115 to print a return address, and then position meter 115 to print a mailing address, and then to print postage.

The printer 140 may be capable of printing on any suitable substrate or media, including an adhesive or tacky substrate, and may also be capable of applying a covering over the printed items. For example, the printer 140 may be capable of applying a film or coating over a printed item for protection or to prevent tampering.

The printer 140 may be an inkjet, dye sublimation, thermal wax, laser, electrostatic, xerographic, thermal, RF, or any suitable type of printer. In one embodiment, printer 140 may utilize energy beams, having high or low power, for example, RF beams, to print directly onto a substrate.

The control functions performed by microprocessor 118 may include utilizing communications port 117 to communicate with the postal infrastructure data center 130 through the first communication network 120. The antenna 190 and support circuitry 195, as well as the other signaling devices 200 may support such communication using wireless or wireline technology.

Referring again to FIG. 1, first network 120 may include any suitable communications network, for example, the Public Switched Telephone Network (PSTN), a wireless network, a wired network, a Local Area Network (LAN), a Wide Area Network (WAN), virtual private network (VPN), air interface, etc. The air interface may include any suitable wireless communication protocol or signaling techniques or standards, for example TDMA, CDMA, IEEE 802.11, Bluetooth, close range RF, optical, any appropriate satellite communication standards, etc.

As another feature of the disclosed embodiments, meter 115 may have the capability to access the postal infrastructure data center 130 directly or through second communications network 150 to download updates or additional service capability as desired. For example, meter 115 may access the postal infrastructure data center 130 to provide delivery confirmation for specific mail pieces.

Second communication network 150 may include any suitable communications network, for example, the Public Switched Telephone Network (PSTN), a wireless network, a wired network, a Local Area Network (LAN), a Wide Area Network (WAN), virtual private network (VPN), an air interface, etc. The air interface may include any suitable wireless communication protocols or signaling techniques or standards, for example TDMA, CDMA, IEEE 802.11, Bluetooth, close range RF, optical, any appropriate satellite communication standards, etc. In one embodiment, the first communication network 120 may be the same as the second communication network 150.

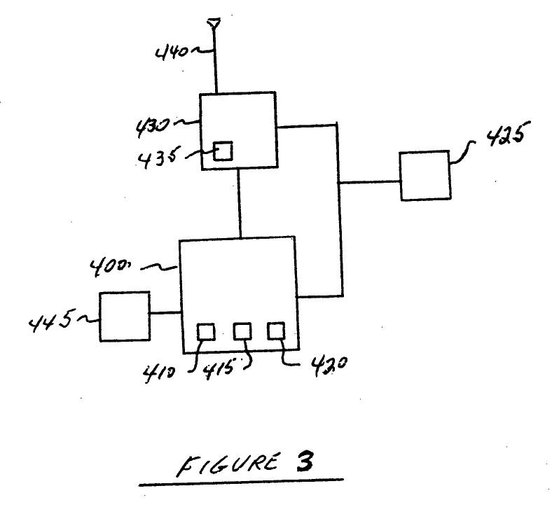

Referring to FIG. 3, the postal infrastructure data center 130 may generally include a server 400, several data bases 410, 415, 420, a power facility 425, for example, a power distribution network, and communication circuitry 430. Communication circuitry 430 may include an antenna 440 and other circuitry and devices 435 for communication with meter 115 through the one or more second networks 125₁ . . . 125ₙ and directly with meter 115.

In other embodiments, devices 435 may include suitable circuitry, programs, transmitters and receivers for any appropriate type of wireless communication utilizing radio frequency (RF), infrared (IR), optical, acoustical, any type of electromagnetic based technology, or any other type of wireless communication. The postal infrastructure data center 130 may also include a user interface facility 445 which may provide local users with access to postal infrastructure data center services.

As mentioned above, the disclosed embodiments are directed to providing tracking numbers to a service provider customer, provide the customer with the ability to associate each tracking number with information about a related or associated mail piece, and to provide tracking services to the customer.

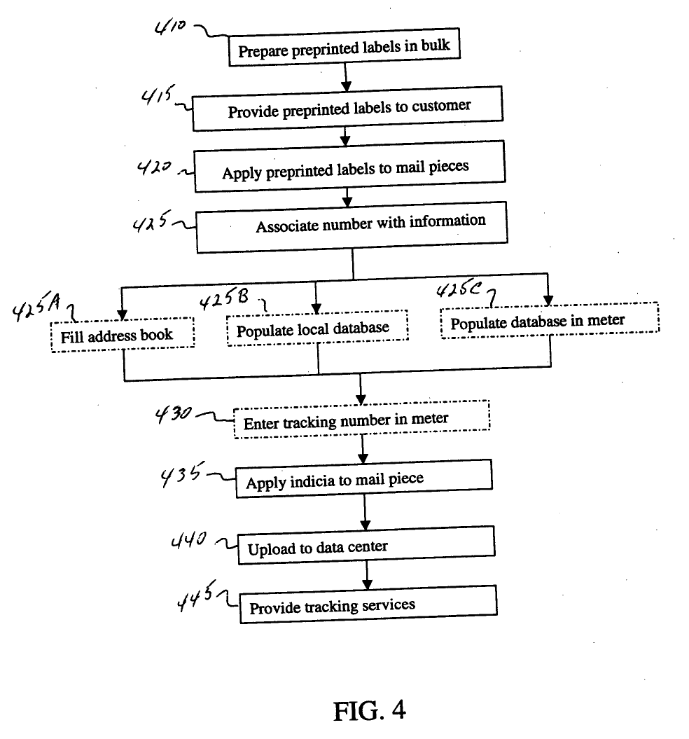

One exemplary process for providing tracking numbers and services is shown in FIG. 4. This process begins with the postal service provider preparing bulk preprinted labels with the tracking numbers, as shown in block 410. The postal service provider may purchase a block of tracking numbers from a carrier and allocate them among a number of customers. It should be noted that while a tracking number is described in the context of a numerical value, a tracking number may be any length and may be made up of any combination of letters, numbers, characters, or any recognizable symbols. The tracking number may be human readable, or may be encoded, for example in the form of a barcode.

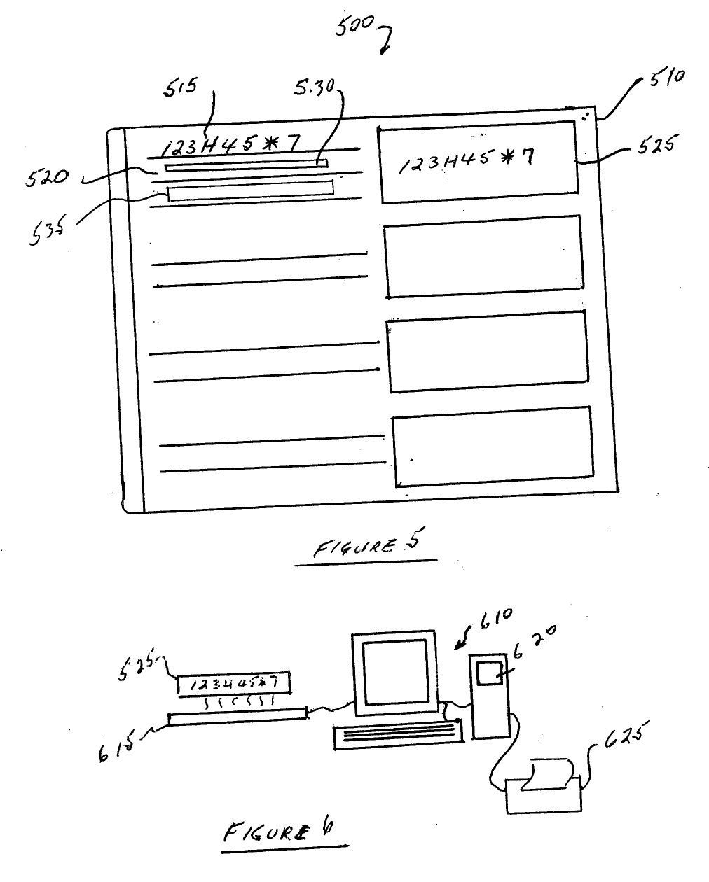

In block 415, the preprinted labels are provided to the customer. In block 420, the customer utilizes the labels by applying them to mail pieces that the customer desires to track. In block 425 information about an individual mail piece is associated with a corresponding tracking number. For example, as shown in block 425A and with reference to FIG. 5, the numbered labels may be supplied to the customer in book form 500. In the book 510, the number 515 of a label 525 and an area 520 for entering mail piece information 530 may be positioned adjacent the label 525. Upon removing the label 525, mail piece information 530 may be entered, for example, printed or written, in the specified area 520.

Returning to FIG. 4, as shown in block 425B with reference to FIG. 6, in another embodiment, the tracking number 515 and mail piece information 530 may associated by entering them into a local database, for example, by hand or by scanning. In FIG. 6, a local database 620 may reside on a processor 610. The processor may operate a scanner 615 and a printer 625. The label 525 may be read by the scanner 615 and the tracking number 515 thus entered into the database 620. Mail piece information 530 may be scanned or may be entered by hand into the database 620.

Returning again to FIG. 4, as shown in block 425C with reference to FIG. 2, the tracking number 515 and mail piece information 530 may also be associated by entering them into the database 250 of meter 115. The mail piece information 530 may generally include the addressee, the addressee zip code, or any other information about the mail piece, either alone or in combination.

As shown in block 430 of FIG. 4, after the mail piece information 530 is associated with the tracking number 515, if not previously done, the tracking number 515 may be entered into the meter 115. As shown in block 435, the meter 115 may then be used to apply indicia to the mail piece. After indicia has been applied to the mail piece, the tracking number 515 may be uploaded to the postal infrastructure data center 130 at an appropriate time, as shown in block 440. Tracking services may then be provided as shown in block 445. The tracking services may generally include collecting the status information from the carrier as described above, processing the information and providing the to the customer.

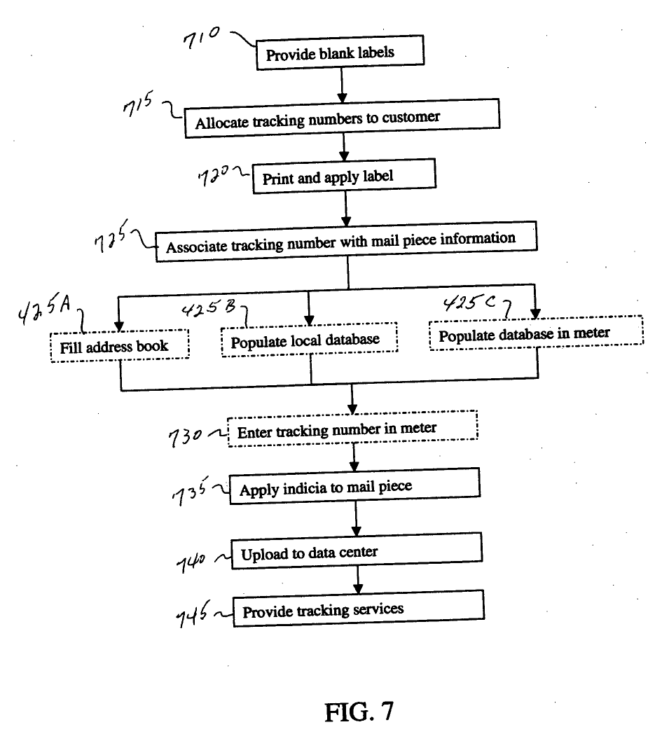

Referring to FIG. 7, another exemplary process for providing tracking numbers and services includes supplying a customer with blank labels and allocating tracking numbers 515 to the customer as needed. In block 710, blank labels are supplied to the customer. In block 715, the postal service provider allocates tracking numbers 515 to the customer as required. For example, the customer may request a certain block of tracking numbers 515 from the postal service provider who in turn provides them to the customer. This exchange may be made by telephone, mail, email, through a web site, or by any other appropriate communication. In one embodiment, the customer may request tracking numbers through the user interface 220 of meter 115. The meter 115 may then communicate with data center 130 to obtain the tracking numbers 515.

The customer may then print one or more labels as required with the tracking numbers, and apply them to mail pieces as shown in block 720. Each tracking number 515 is then associated with information 530 about a particular mail piece as shown in block 725. This association may be accomplished by filling an address book (block 425A), populating a local database (block 425B), or populating a database in the meter 115 (block 425C), as described above.

In block 730, after the mail piece information 530 is associated with the tracking number 515, if not previously done, the tracking number 515 may be entered into the meter 115. As shown in block 735, the meter 115 may then be used to apply indicia to the mail piece. After indicia has been applied to the mail piece, the tracking number 515 may be uploaded to the postal infrastructure data center 130 at an appropriate time, as shown in block 740. Tracking services may then be provided as shown in block 745.

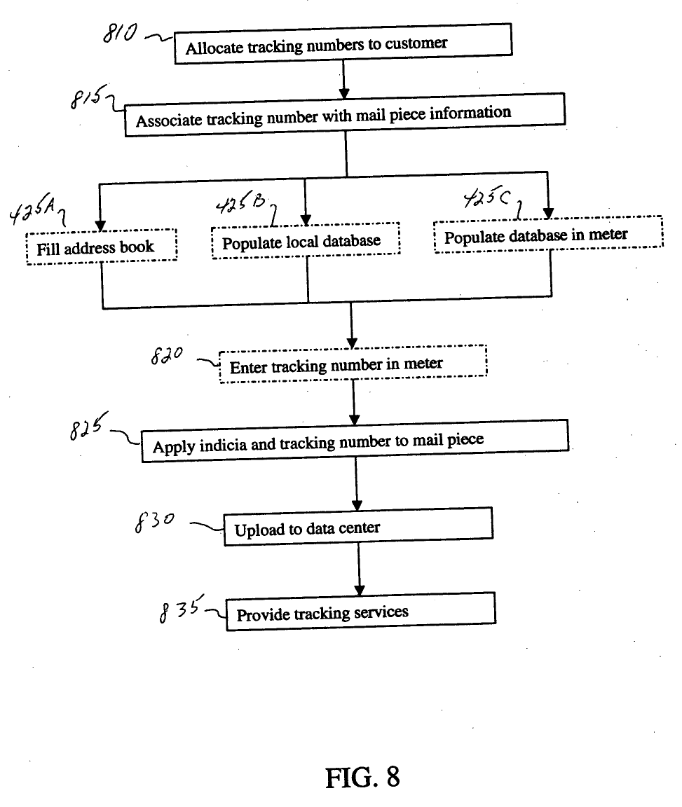

Turning now to FIG. 8, yet another process of the disclosed embodiments includes associating the tracking number with the mail piece information, entering the information into the franking machine, and then printing the tracking number, indicia, and optionally the mail piece information directly onto the mail piece. In this way, the mail piece is marked directly with the tracking number, without the need for a separate label.

As shown in block 810, tracking numbers are allocated to a customer as described above. In block 815, each tracking number 515 is then associated with information 530 about a particular mail piece. As described above, this association may be accomplished by filling an address book (block 425A), populating a local database (block 425B), or populating a database in the meter 115 (block 425C). After the mail piece information 530 is associated with the tracking number 515, the tracking number 515 may be entered into the meter 115 if not previously done, as shown in block 820. The meter 115 may then be used to apply indicia and the tracking number to the mail piece, as shown in block 825. The tracking number 515 may then be uploaded to the postal infrastructure data center 130, as shown in block 830. As shown in block 835, tracking services may then be provided.

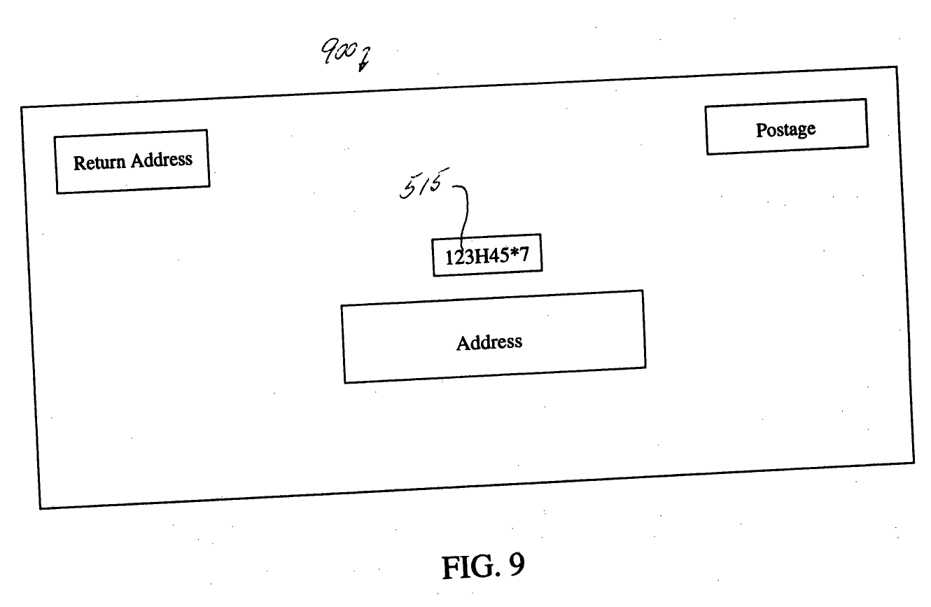

FIG. 9 shows an exemplary mail piece 900 bearing a tracking number 515. As mentioned above, the tracking number 5151 may be applied on a label or may be printed directly onto the mail piece 900.

It should be understood that the foregoing description is only illustrative of the invention. Various alternatives and modifications can be devised by those skilled in the art without departing from the invention. Accordingly, the present invention is intended to embrace all such alternatives, modifications and variances.

What is claimed is:

1. A method of providing mail piece labeling and tracking comprising:
allocating at least one tracking number a postal service provider customer;
associating the at least one tracking number with information about a mail piece;
applying the at least one tracking number to the mail piece; and
using the at least one tracking number to track the delivery progress of the mail piece.

2. The method of claim 1, wherein associating the at least one tracking number with information about a mail piece includes:
supplying the customer with a book of labels preprinted with the at least one tracking number; and
entering the information about the mail piece in the book adjacent to an indication of the at least one tracking number.

3. The method of claim 1, wherein associating one of the tracking numbers with information about a mail piece includes entering the one of the tracking numbers and the information about the mail piece in a database.

4. The method of claim 4, wherein the database resides in a meter used to apply indicia to the mail piece.

5. The method of claim 1, wherein associating the at least one tracking number with information about a mail piece includes:
supplying the customer with at least one blank label;
printing the at least one tracking number onto the label when required; and
entering the information about the mail piece into a database,
and wherein applying the tracking number to the mail piece includes applying the printed label to the mail piece.

6. The method of claim 1, wherein applying the at least one tracking number to the mail piece includes entering the tracking number into a franking device and using the franking device to print the tracking number directly onto the mail piece.
